(19) United States
(12) Patent Application Publication
(10) Pub. No.: US 2024/0151106 A1
(43) Pub. Date: May 9, 2024

(54) SUPPORTING FRAME AND STEPLADDER USING SUPPORTING FRAME

(71) Applicant: New-Tec Integration (Xiamen) Co., Ltd., Xiamen City (CN)

(72) Inventor: Luhao LENG, Xiamen City (CN)

(21) Appl. No.: 18/140,558

(22) Filed: Apr. 27, 2023

(30) Foreign Application Priority Data
Nov. 3, 2022 (CN) 202222963434.4

(51) Int. Cl. E06C 1/393; E06C 1/20

(52) U.S. Cl. CPC E06C 1/393; E06C 1/20; E06C 1/387

(57) ABSTRACT

A supporting frame and a stepladder using the supporting frame are provided. The supporting frame comprises two supporting legs symmetrically parallelly arranged in a left-and-right direction and two lateral rods symmetrically parallelly arranged in an up-and-down direction. The two lateral rods are connected to and extend between the two supporting legs, and an outer surface of each of the two supporting legs comprises a groove. An end portion of each of the two lateral rods is disposed with a sleeve sleeved on a corresponding one of the two supporting legs, and a part of the sleeve corresponding to the groove is configured to be pressed to move into the groove so as to enable the sleeve to embrace the corresponding one of the two supporting legs to achieve an interference fit connection.

### RELATED APPLICATIONS

This application claims priority to Chinese patent application number 202222963434.4, filed on Nov. 3, 2022. Chinese patent application number 202222963434.4 is incorporated herein by reference.

### FIELD OF THE DISCLOSURE

The present disclosure relates to a supporting frame and a stepladder using the supporting frame.

### BACKGROUND OF THE DISCLOSURE

A support frame with a simple structure uses two parallel and symmetrical support legs in a left-and-right direction to bear the main gravity. At the same time, two lateral bars are installed between the two support legs. A first bar of the two lateral bars is connected to the two support legs on an upper part, and a second bar of the two lateral bars is connected to the two support legs on a lower part so as to achieve an effect of limiting a relative position of the two support legs to improve a support stability. For example, a lateral bar is added between rear support legs on a rear side of a step stool (ladder/stool). Although adding the two lateral bars between the two support legs respectively on the upper part and the lower part can improve the support stability to a certain extent, a rectangular frame, like a rhombus, formed by the two support legs and the two lateral bars is still easy to shake. Therefore, on this basis, many support frames add oblique connecting rods in accordance with a theorem of triangular stability, that is, adding two oblique connecting rods with an X intersection. The X-crossed oblique connecting rods greatly improve the support stability, but result in an increase in the number of support frame components and a complex structure.

### BRIEF SUMMARY OF THE DISCLOSURE

The present disclosure provides a supporting frame and a stepladder using the supporting frame to solve the deficiencies in the background, which has a simple structure and improved stability.

In order to solve the technical problem, a first technical solution of the present disclosure is as follows.

A supporting frame comprises two supporting legs symmetrically parallelly arranged in a left-and-right direction and two lateral rods symmetrically parallelly arranged in an up-and-down direction. The two lateral rods are connected to and extend between the two supporting legs, and an outer surface of each of the two supporting legs comprises a groove. An end portion of each of the two lateral rods is disposed with a sleeve sleeved on a corresponding one of the two supporting legs, and a part of the sleeve corresponding to the groove is configured to be pressed to move into the groove so as to enable the sleeve to embrace the corresponding one of the two supporting legs to achieve an interference fit connection.

In a preferred embodiment, the outer surface of each of the two supporting legs is circular.

In a preferred embodiment, the two supporting legs are hollow round tubes, and the groove is formed by stamping.

In a preferred embodiment, the two supporting legs are injection-molded plastic parts.

In a preferred embodiment, the part of the sleeve corresponding to the groove is pressed by stamping.

In a preferred embodiment, a cross section of the groove is arc-shaped.

In a preferred embodiment, the sleeve is made of iron or aluminum.

In a preferred embodiment, the two supporting legs are obliquely supported on ground.

A stepladder comprises two front supporting legs symmetrically parallelly arranged in a left-and-right direction, two rear supporting legs symmetrically parallelly arranged in the left-and-right direction, at least one step platform, and two lateral rods symmetrically parallelly arranged in an up-and-down direction. A left side and a right side of the at least one step platform are respectively pivotally connected to the two front supporting legs, and one of the two front supporting legs and one of the two rear supporting legs which are disposed on a same side of the stepladder are connected to each other in a splayed shape. The two lateral rods are connected to and extend between the two rear supporting legs, and an outer surface of each of the two rear supporting legs comprises a groove. An end portion of each of the two lateral rods is disposed with a sleeve sleeved on a corresponding one of the two rear supporting legs, and a part of the sleeve corresponding to the groove is configured to be pressed to move into the groove so as to enable the sleeve to embrace the corresponding one of the two rear supporting legs to achieve an interference fit connection.

In a preferred embodiment, the two rear supporting legs are hollow round tubes, a cross section of the groove is arc-shaped, the groove is formed by stamping, and the part of the sleeve corresponding to the groove is pressed by stamping.

Compared with the existing techniques, the technical solution has the following advantages.

1. The two lateral rods are not directly connected to the two supporting legs or the two rear supporting legs, but the end portion of each of the two lateral rods is disposed with the sleeve. Then, the sleeve is sleeved on the two supporting legs or the two rear supporting legs. In this way, the sleeve securely embraces the two supporting legs or the two rear supporting legs from an outside of the supporting legs or the two rear supporting legs, and the sleeve and the two supporting legs or the two rear supporting legs are in surface-to-surface contact, which greatly improves the firmness of the connection. Therefore, the supporting frame formed by the two lateral rods and the two supporting legs or the two rear supporting legs is quite stable, and anti-torsion and anti-sway performance have been greatly improved. At the same time, an interference fit can be realized by pressing the sleeve so that the part corresponding to the groove moves into the groove, and the assembly is very convenient.

2. The sleeve securely embraces the two supporting legs or the two rear supporting legs, which enhances the strength of the two supporting legs or the two rear supporting legs and improves a load-bearing capacity.

### BRIEF DESCRIPTION OF THE DRAWINGS

FIG. 1 illustrates a perspective view of a stepladder.

FIG. 2 illustrates another perspective view of the stepladder illustrated in FIG. 1.

FIG. 3 illustrates a perspective view of a supporting frame of the stepladder defined by two rear supporting legs and two lateral rods illustrated in FIG. 1.

FIG. 4 illustrates a top view of the two lateral rods of the supporting frame illustrated in FIG. 3 before being assembled.

FIG. 5 illustrates a cross-sectional view of the two rear supporting legs of the supporting frame illustrated in FIG. 3.

FIG. 6 illustrates a perspective view of the supporting frame illustrated in FIG. 3 when the supporting frame is in an assembly process.

FIG. 7 illustrates a perspective view of a sleeve of the supporting frame illustrated in FIG. 3, when the sleeve is sleeved on the two rear supporting legs and the two rear supporting legs are not pressed.

FIG. 8 illustrates a cross-sectional view of the sleeve being sleeved on the two rear supporting legs illustrated in FIG. 7, when the two rear supporting legs are not pressed.

FIG. 9 illustrates a cross-sectional view of the sleeve being pressed to securely embrace the two rear supporting legs.

### DETAILED DESCRIPTION OF THE EMBODIMENTS

The present disclosure will be further described below in combination with the accompanying drawings and embodiments.

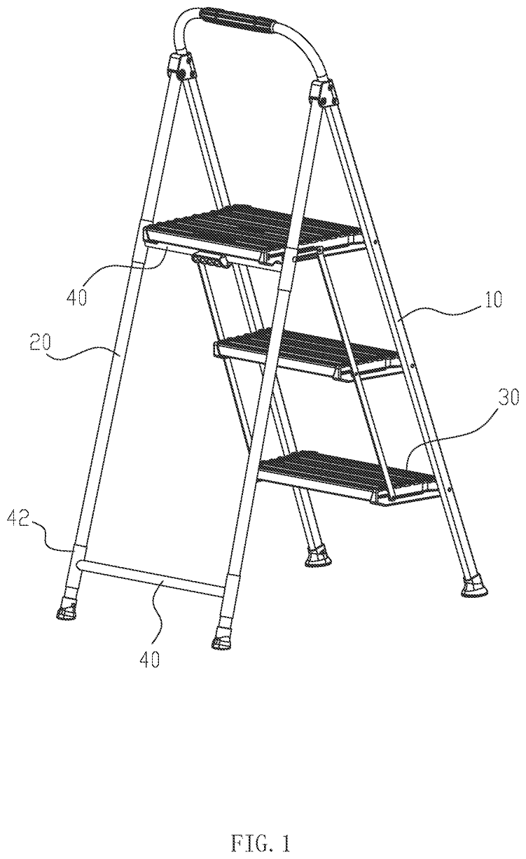

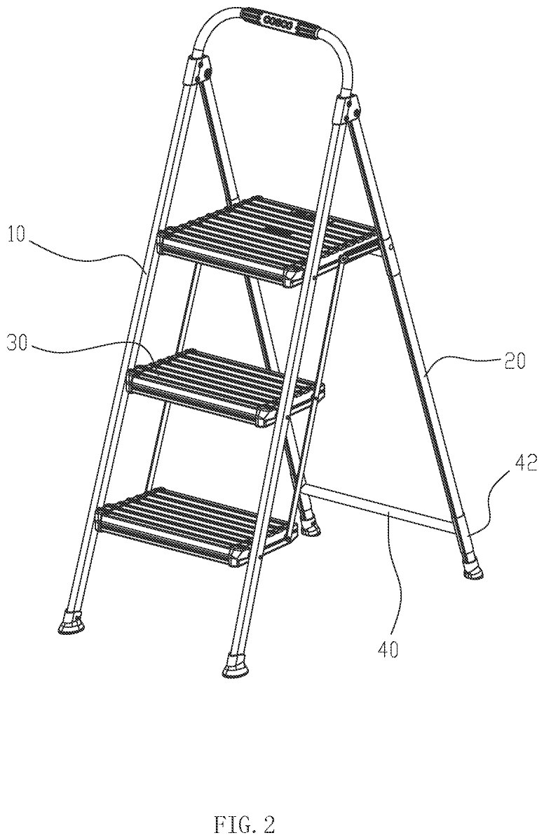

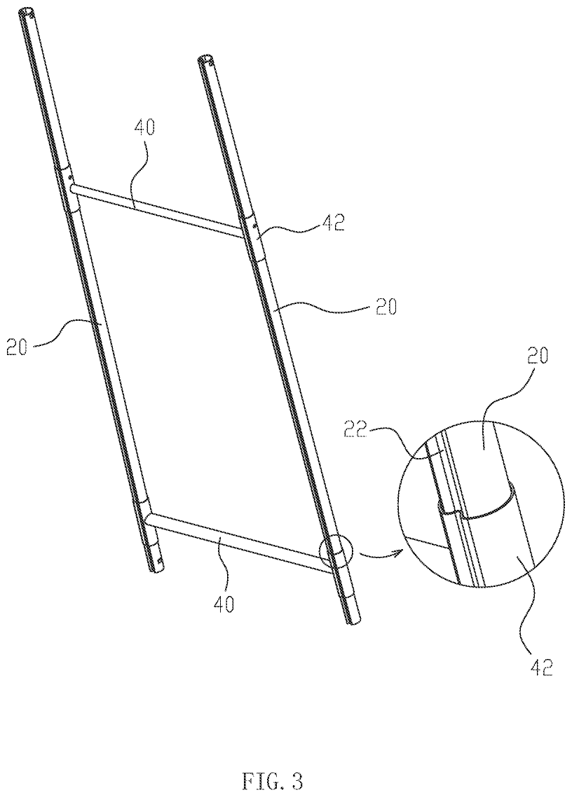

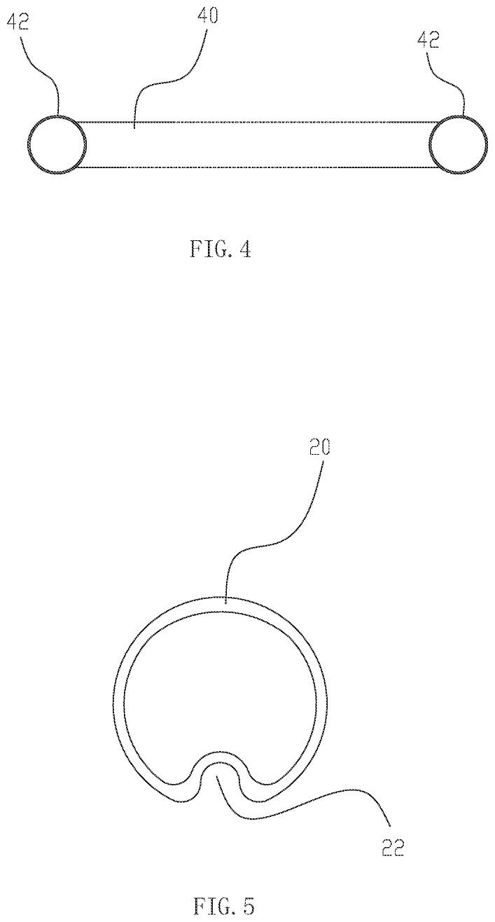

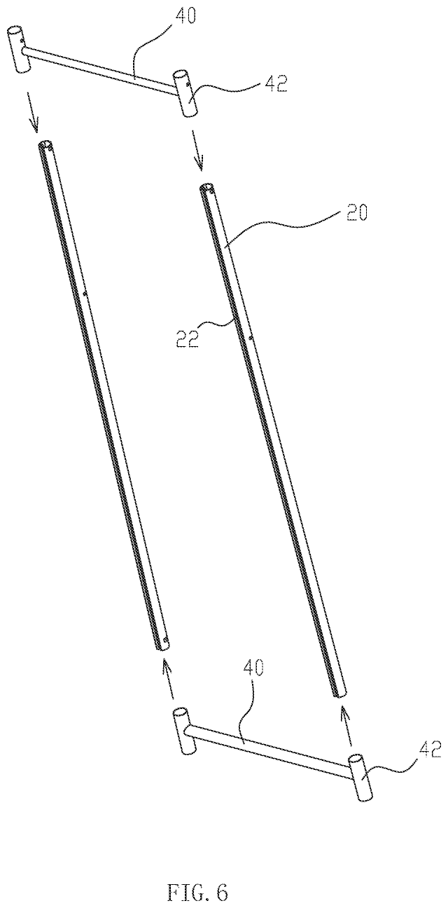

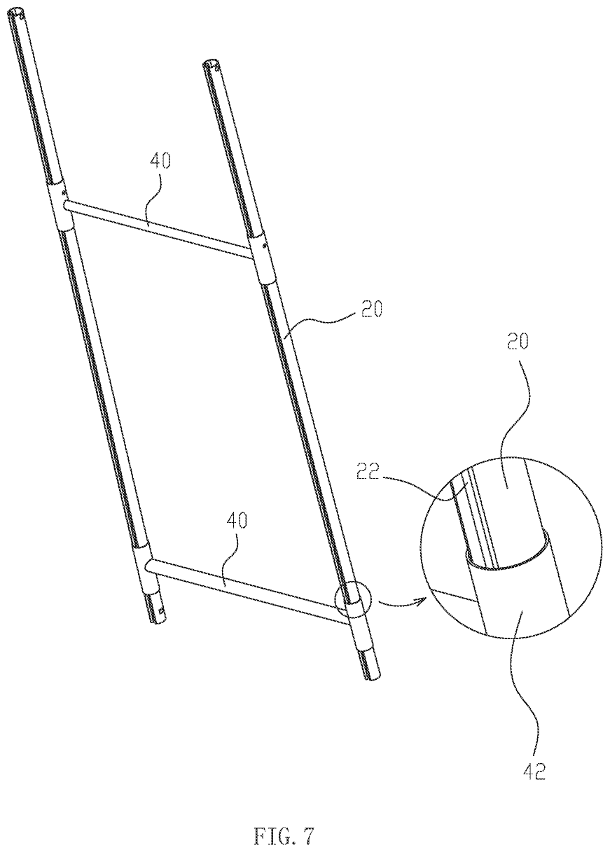

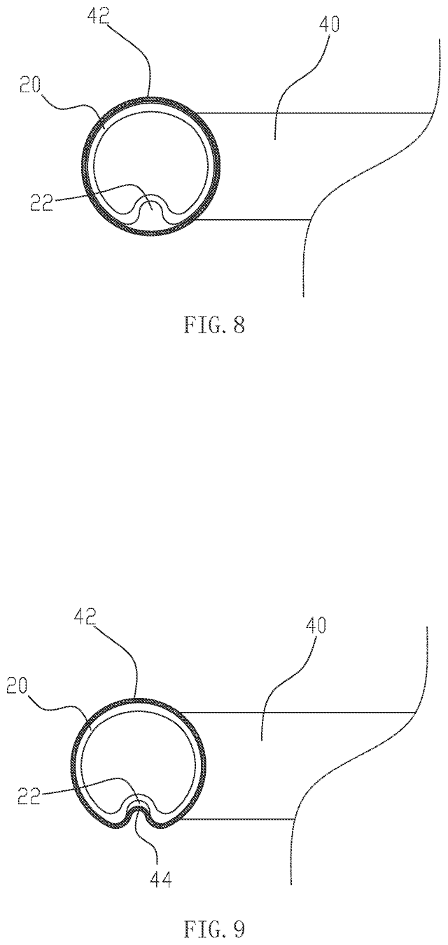

Referring to FIGS. 1 to 9, a ladder and a stool can be referred to as a stepladder, and the stepladder comprises two front supporting legs 10 symmetrically parallelly arranged in a left-and-right direction, two rear supporting legs 20 symmetrically parallelly arranged in the left-and-right direction, at least one step platform 30, and two lateral rods 40 symmetrically parallelly arranged in an up-and-down direction. A left side and a right side of the at least one step platform 30 are respectively pivotally connected to the two front supporting legs 10. One of the two front supporting legs 10 and one of the two rear supporting legs 20 that are disposed on a same side of the stepladder are connected to each other in a splayed shape. The two lateral rods 40 are connected to and extend between the two rear supporting legs 20. A folding structure defined by the two front supporting legs 10, the two rear supporting legs 20, and the at least one step platform 30 is existing technology, which will not be further described. An outer surface of each of the two rear supporting legs 20 comprises a groove 22, and an end portion of each of the two lateral rods 40 is disposed with a sleeve 42 sleeved on a corresponding one of the two rear supporting legs 20. A diameter of the sleeve 42 is slightly greater than that of the corresponding one of the two rear supporting legs 20 to facilitate insertion. A part of the sleeve 42 corresponding to the groove 22 is configured to be pressed to move into the groove 22 so as to enable the sleeve 42 to securely embrace the corresponding one of the two rear supporting legs 20 to achieve an interference fit connection. Referring to FIG. 9, it can be clearly seen that the sleeve 42 is deformed after being pressed to form an inserting portion 44 corresponding to the groove 22. It can be understood that the sleeve 42 shrinks inwardly and securely embraces the corresponding one of the two rear supporting legs 20 during a pressing process.

It can be understood that a supporting frame defined by the two rear supporting legs 20 and the two lateral rods 40 can effectively prevent the two rear supporting legs 20 and the two lateral rods 40 from being twisted relative to each other using the sleeve 42 securely embracing the two rear supporting legs 20 to form a surface-to-surface contact structure having a large contact surface. When the stepladder is opened to be in a use state, the two rear supporting legs 20 can be obliquely supported on the ground very steadily.

Preferably, the two rear supporting legs 20 are hollow round tubes, and a cross section of the groove 22 is arc-shaped. The groove 22 is formed by stamping, and the part of the sleeve 42 corresponding to the groove 22 is pressed by stamping.

Preferably, the outer surface of each of the two rear supporting legs 20 is circular, more preferably a hollow tube. The groove 22 is formed by stamping. The two rear supporting legs 20 may be injection-molded plastic parts, iron parts, aluminum parts, or plastic-clad steel parts. The sleeve 42 is preferably iron or aluminum.

Preferably, a cross section of the groove 22 is arc-shaped.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A supporting frame, comprising:
two supporting legs symmetrically parallelly arranged in a left-and-right direction, and
two lateral rods symmetrically parallelly arranged in an up-and-down direction, wherein:
the two lateral rods are connected to and extend between the two supporting legs,
an outer surface of each of the two supporting legs comprises a groove,
an end portion of each of the two lateral rods is disposed with a sleeve sleeved on a corresponding one of the two supporting legs, and
a part of the sleeve corresponding to the groove is configured to be pressed to move into the groove so as to enable the sleeve to embrace the corresponding one of the two supporting legs to achieve an interference fit connection.

2. The supporting frame according to claim 1, wherein:
the outer surface of each of the two supporting legs is circular.

3. The supporting frame according to claim 2, wherein:
the two supporting legs are hollow round tubes, and
the groove is formed by stamping.

4. The supporting frame according to claim 1, wherein:
the two supporting legs are injection-molded plastic parts.

5. The supporting frame according to claim 1, wherein:
the part of the sleeve corresponding to the groove is pressed by stamping.

6. The supporting frame according to claim 1, wherein:
a cross section of the groove is arc-shaped.

7. The supporting frame according to claim 1, wherein:
the sleeve is made of iron or aluminum.

8. The supporting frame according to claim 1, wherein:
the two supporting legs are obliquely supported on ground.

9. The supporting frame according to claim 2, wherein:
the two supporting legs are injection-molded plastic parts.

10. The supporting frame according to claim 5, wherein:
a cross section of the groove is arc-shaped.

11. A stepladder, comprising:
two front supporting legs symmetrically parallelly arranged in a left-and-right direction,
two rear supporting legs symmetrically parallelly arranged in the left-and-right direction,
at least one step platform, and
two lateral rods symmetrically parallelly arranged in an up-and-down direction, wherein:
a left side and a right side of the at least one step platform are respectively pivotally connected to the two front supporting legs,
one of the two front supporting legs and one of the two rear supporting legs which are disposed on a same side of the stepladder are connected to each other in a splayed shape,
the two lateral rods are connected to and extend between the two rear supporting legs,
an outer surface of each of the two rear supporting legs comprises a groove,
an end portion of each of the two lateral rods is disposed with a sleeve sleeved on a corresponding one of the two rear supporting legs, and
a part of the sleeve corresponding to the groove is configured to be pressed to move into the groove so as to enable the sleeve to embrace the corresponding one of the two rear supporting legs to achieve an interference fit connection.

12. The stepladder according to claim 11, wherein:
the two rear supporting legs are hollow round tubes,
a cross section of the groove is arc-shaped,
the groove is formed by stamping, and
the part of the sleeve corresponding to the groove is pressed by stamping.
